(19) United States
(12) Patent Application Publication
(10) Pub. No.: US 2026/0337922 A1
(43) Pub. Date: Oct. 29, 2026

(54) OPERATOR STARTUP GUIDANCE AND OPTION IDENTIFICATION SYSTEM AND METHOD

(71) Applicant: MANITOU EQUIPMENT AMERICA, LLC, West Bend, WI (US)

(72) Inventors: Caleb OLLA, Lee's Summit, MO (US); Michael BRAUN, Oconomowoc, WI (US)

(21) Appl. No.: 19/114,597

(22) PCT Filed: Sep. 25, 2023
(86) PCT No.: PCT/US2023/075061

§ 371 Date: Mar. 24, 2025

(51) Int. Cl. E02F 9/20; B60K 35/10; E02F 9/16; E02F 9/26

(52) U.S. Cl. CPC E02F 9/2004; B60K 35/10; E02F 9/16; E02F 9/26; B60K 2360/128; B60K 2360/197; B60K 2360/33

(57) ABSTRACT

A utility vehicle including a startup guidance system and user interface with a plurality of interactive indicators configured to provide sensory output to the operator. The vehicle control system provides operator guidance through a programmed vehicle startup sequence.

### CROSS-REFERENCES TO RELATED APPLICATIONS

This application claims priority under 35 U.S.C. § 119 to U.S. Provisional Patent Application No. 63/376,846, filed Sep. 23, 2022, entitled “Operator Startup Guidance and Option Identification,” the entire contents of which are incorporated herein by reference for all purposes.

### BACKGROUND

Utility vehicles and work machines, such as loaders, telehandlers, forklifts, and the like, are built, sold, and rented with different options installed. Additionally, there are many different models of controllers, ignition mechanisms, and hydraulic unlock switches in the work machine industry, which requires vehicle operators to learn a new convention for vehicle control for each model of control. Accordingly, vehicle operators can often be confused by the controls of a vehicle with which the operator is newly acquainted, especially in instances where the vehicle is rented. Further, users do not have an efficient way of determining which features are installed on the utility vehicle without referencing a detailed user manual or receiving formal training on each specific piece of equipment.

While many utility vehicles have similar functions and are operated similarly, there is an inconsistency between the controls and features installed on specific machines and between different brands. There are also a significant number of novice users who rent utility vehicles for temporary projects and do not operate machinery regularly. These inexperienced operators may not be familiar with the startup or operating procedure for the specific vehicle they are operating. Even for experienced operators, it can be difficult to tell which features are installed on a specific vehicle. Accordingly, an improved system and method for assisting utility vehicle operators with vehicle startup and control is needed.

### SUMMARY

It can be helpful to provide an operator guidance system to provide visual indicators to guide an operator unfamiliar with the utility vehicle machine through the startup and operating procedure, while also providing clear indication of which features are installed on a specific utility vehicle. An operator startup guidance system can also improve operator and job site safety because certain machine functions may not be enabled unless the operator follows a programmable startup sequence saved into the memory of the vehicle controller.

Some embodiments provide an operator control guidance system of a utility vehicle or other types of work machines. The operator control guidance system can include a vehicle controller mounted within an operator cab of the utility vehicle that includes a control circuit including a processor and a memory unit configured to store a programmable sequence, a user interface including a plurality of interactive indicators, and an illumination element. The interactive indicators can include at least one user interface icon, and the plurality of interactive indicators can correspond to a plurality of actuators. The illumination element is configured to selectively illuminate each of the plurality of interactive indicators. The programmable sequence includes a first operation and a second operation. The first operation includes illuminating a first interactive indicator of the plurality of interactive indicators, and the second operation includes illuminating a second interactive indicator of the plurality of indicators.

In some forms, the control circuit includes a power mechanism configured to initiate a plurality of vehicle functions. The processor can be in communication with an operator presence sensor, wherein the operator presence sensor is configured to detect a presence of a vehicle operator. The operator presence sensor can be a switch. The programmable sequence can include a vehicle startup sequence, and the vehicle startup sequence can include a plurality of operations configured to provide power to the utility vehicle, initiate an engine, and enable one or more functions of the utility vehicle. The first operation, the first interactive indicator, and a first actuator can correspond with providing power to the utility vehicle, and the second operation, the second interactive indicator, and a second actuator can correspond to initiating the engine. In some forms, the vehicle controller executes the programmable sequence, wherein the vehicle controller initiates the second operation after the first operation has been initiated.

Some embodiments provide an operator control system for a utility vehicle controlled by a user and adapted to be coupled to the utility vehicle, the operator control system including an operator seat in communication with an operator presence sensor, and a vehicle controller with a user interface and a control circuit. The user interface is configured to receive an operator input. The control circuit includes a processor and a memory unit and is configured to store a programmable sequence. The processor is in communication with the operator presence sensor and the user interface. The processor can be configured to selectively illuminate the user interface based on the output of the operator presence sensor and operator inputs. The processor is configured to iteratively update a status of the programmable sequence based on the output of the operator presence sensor and the operator input. The processor enables at least one of a plurality of functions of the utility vehicle and selectively illuminates the user interface based on the status of the programmable sequence.

In some forms, the at least one of the plurality of functions of the utility vehicle is enabled after a passcode is entered via the user interface. The user interface can include a plurality of interactive indicators. In some forms, the selective illumination of the user interface includes one or more of a pulsating illumination or a solid illumination. In some forms, the processor updates the status of the programmable sequence if the operator input matches a next operation in the programmable sequence. In some forms, the programmable sequence includes a plurality of operations configured to provide power to the utility vehicle, initiate an engine, and initiate one or more functions of the utility vehicle. In some forms, the operator control system includes a plurality of actuators, wherein a first operation, a first interactive indicator, and a first actuator correspond with a first vehicle function of the programmable sequence, and a second operation, a second interactive indicator, and a second actuator correspond to a second vehicle function of the programmable sequence.

Some embodiments provide a vehicle startup sequence method for a utility vehicle. The method includes providing a plurality of interactive indicators on a user interface, the plurality of interactive indicators corresponding to a plurality of vehicle functions, providing a first sensory indicator for a first operation in a vehicle startup sequence, wherein the first operation in the vehicle startup sequence includes selecting a first interactive indicator of the plurality of interactive indicators, receiving a first selection of the first interactive indicator, initiating a first vehicle function of the plurality of vehicle functions after receiving the first selection of the first interactive indicator and providing a second sensory indicator of the first operation in the vehicle startup sequence, providing the first sensory indicator for a second operation in the vehicle startup sequence after initiating the first vehicle function, wherein the second operation in the vehicle startup sequence includes selecting a second interactive indicator of the plurality of interactive indicators, and initiating a second vehicle function of the plurality of vehicle functions after receiving a second selection of the second interactive indicator and providing the second sensory indicator of the second operation in the vehicle startup sequence.

In some forms, the method further includes the step of receiving a signal from an operator presence sensor for detecting a presence of an operator, wherein the first sensory indicator of the first operation in the vehicle startup sequence is provided in response to sensing the presence of the operator. In some forms, powering the utility vehicle is the first operation in the vehicle startup sequence, and initiating an engine of the utility vehicle is the second operation in the vehicle startup sequence. In some forms, the method further includes the step of illuminating each of the plurality of interactive indicators and enabling a remainder of the plurality of vehicle functions after initiating the second vehicle function and detecting a completion of the vehicle startup sequence. In some forms, the first sensory indicator is a pulsating illumination, and the second sensory indicator is a solid illumination. In some forms, initiating the second operation in the vehicle startup sequence occurs after initiating the first operation in the vehicle startup sequence.

Some embodiments provide an operator control system for a utility vehicle, the operator control system controlled by a user and adapted to be coupled to the utility vehicle. The operator control system can include a function status sensor configured to detect an availability of one or more vehicle functions, and a vehicle controller includes a user interface and a control circuit. The user interface is configured to receive an operator input. The control circuit includes a processor. The processor is in communication with the function status sensor and the user interface and is configured to selectively illuminate the user interface based on an output of the function status sensor and selectively illuminate the user interface based on the operator input.

In some forms, the control circuit includes an actuator to initiate a plurality of vehicle functions. In some forms, the user interface is selectively illuminated in response to an operator presence sensor sensing a presence of an operator. In some forms, the user interface includes a plurality of interactive indicators, wherein the plurality of interactive indicators are selectively illuminated with one or more illumination settings based on the output of the function status sensor. In some forms, the one or more illumination settings include a first illumination setting, a second illumination setting, and a third illumination setting. In some forms, the first illumination setting is activated when the function status sensor detects that the one or more vehicle functions are installed, and the second illumination setting is activated when the function status sensor detects that the one or more vehicle functions are initiated, and the third illumination setting is activated when the function status sensor detects that the one or more vehicle functions are unavailable. In some forms, the first illumination setting and the second illumination setting include pulsating illumination. In some forms, the second illumination setting is initiated after the operator input is received.

Some embodiments provide a method for selectively illuminating a vehicle controller. The method can include providing a plurality of interactive indicators on a user interface that correspond to a plurality of vehicle functions. The method can further include receiving outputs from a plurality of function status sensors, where the sensors can be configured to detect a vehicle function status of the plurality of vehicle functions. Upon receiving a selection of one of the plurality of interactive indicators by the operator input, the method includes initiating a vehicle function corresponding to the selected interactive indicator and updating the vehicle function status of the vehicle function corresponding to the selected interactive indicator. The method includes selectively illuminating the plurality of interactive indicators based on the vehicle function status of the plurality of vehicle functions.

In some forms, the vehicle function status is one of a function installed status, a function initiated status, or a function unavailable status. In some forms, the plurality of interactive indicators are selectively illuminated with a first illumination when the vehicle function status is the function initiated status, and the first illumination includes one or both of a colored or pulsating light. In some forms, the plurality of interactive indicators are selectively illuminated with a second illumination when the vehicle function status is the function initiated status, and the second illumination includes a colored light. In some forms, the plurality of interactive indicators are selectively illuminated with a third illumination when the vehicle function status is the function unavailable status, and the third illumination includes an inactive illumination.

Some embodiments provide a method for providing sensory feedback using a vehicle controller. The method includes providing a plurality of interactive indicators on a user interface that correspond to a plurality of vehicle functions, receiving a plurality of outputs from a plurality of sensors, where each of the plurality of sensors are configured to detect a vehicle function status of one or more of the plurality of vehicle functions, receiving a selection of one of the plurality of interactive indicators, initiating a vehicle function corresponding to the selected one of the plurality of interactive indicators, updating the vehicle function status of the vehicle function in response to the vehicle function being initiated, and providing sensory feedback from the plurality of interactive indicators based on the vehicle function status of the plurality of vehicle functions.

In some forms, the sensory feedback includes providing an audible signal, a colored illumination, a haptic signal, or a combination thereof. In some forms, the vehicle function status is one of a function installed status, a function initiated status, or a function unavailable status. In some forms, the method includes the step of providing a first sensory feedback when the vehicle function status is function installed. In some forms, the method includes the step of providing a second sensory feedback when the vehicle function status is function initiated. In some forms, the method includes the step of providing a third sensory feedback when the vehicle function status is function unavailable.

### BRIEF DESCRIPTION OF THE DRAWINGS

The accompanying drawings, which are incorporated in, and form a part of, this specification, illustrate embodiments of the invention and, together with the description, serve to explain the principles of embodiments of the invention:

FIG. 1 is a front isometric view of a utility vehicle according to an embodiment;

FIG. 2 is a partial front isometric view of a cab portion of the utility vehicle of FIG. 1;

FIG. 3 is a top plan view of a vehicle controller according to an embodiment;

FIG. 4 is a block diagram of a method for selectively illuminating a plurality of interactive indicators according to an embodiment;

FIG. 5 is a block diagram of a method for a vehicle operator guidance system corresponding to a vehicle startup sequence according to an embodiment;

FIG. 6 is a block diagram of a method for selectively illuminating a plurality of interactive indicators according to an embodiment; and

FIG. 7A-7D are illustrations of visual graphics on a display interface according to an embodiment.

### DETAILED DESCRIPTION

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the attached drawings. The invention is capable of other embodiments and of being practiced or of being carried out in various ways. Also, it is to be understood that the phraseology and terminology used herein are for the purpose of description and should not be regarded as limiting. For example, the use of “including,” “comprising,” or “having” and variations thereof herein is meant to encompass the items listed thereafter and equivalents thereof as well as additional items.

As used herein, unless otherwise specified or limited, the terms “mounted,” “connected,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings.

As used herein, unless otherwise specified or limited, “at least one of A, B, and C,” and similar other phrases, are meant to indicate A, or B, or C, or any combination of A, B, and/or C. As such, this phrase, and similar other phrases can include single or multiple instances of A, B, and/or C, and, in the case that any of A, B, and/or C indicates a category of elements, single or multiple instances of any of the elements of the categories A, B, and/or C.

As explained above, operator control systems for utility vehicles or other work machines can benefit from a guided startup and operation sequence that provides sensory indications to demonstrate the steps or operations an operator should perform in a vehicle startup sequence. Different models of utility vehicles, for example, can include a user interface and a variety of installed features, which can make starting and operating the vehicle difficult and inefficient to learn, especially for an inexperienced operator or an operator unfamiliar with the specific machine being operated.

Some embodiments disclosed herein provide a vehicle controller configured to provide a sensory indication to an operator to guide the operator through vehicle startup and operation. The vehicle controller can be configured to provide sensory indications of a plurality of installed features available on a utility vehicle. The vehicle controller can also be configured to provide sensory indications of a plurality of vehicle features that are initiated, active, and/or inactive. In this way, the operator can receive guidance during vehicle startup and operation.

There can be multiple types or levels of sensory indication, where each level may be associated with (1) the features that are installed or enabled and capable of being initiated by an operator, (2) the vehicle functions that have been initiated or are active, (3) the vehicle functions or features that are not installed or enabled and not capable of being initiated or activated by the operator, and (4) vehicle functions that are installed or enabled, but not initiated or active. Hereinafter, features that are installed and capable of being activated are referred to as “installed” but also include features that are enabled or may be enabled after entering a passcode. Similarly, if an embodiment refers to a vehicle function being “initiated,” it should be understood that the vehicle function can also be referred to as being started, powered on, operating, or otherwise active. Additional embodiments may include additional sensory indication levels or types according to different vehicle configurations and applications.

Although some examples below focus expressly on sensory indication via illumination and audible signals, other sensory indication means can be included in some embodiments. For example, in some embodiments, vehicle control systems can include haptic feedback in addition to the illumination/audible sensory indication.

Some examples below focus expressly on a user interface via a vehicle controller, although other user interfaces can be included in some embodiments. For example, in some embodiments, the user interface can include a touchscreen or display module in addition to the vehicle controller interface.

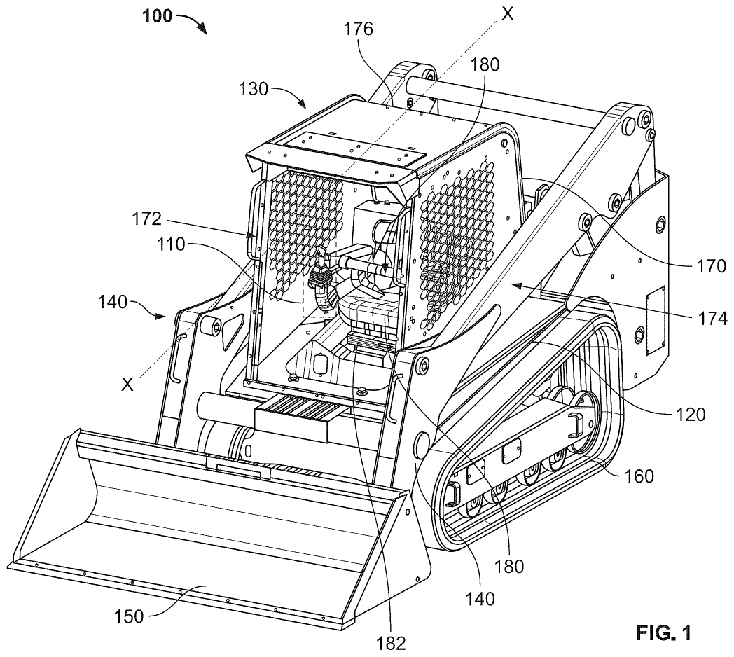

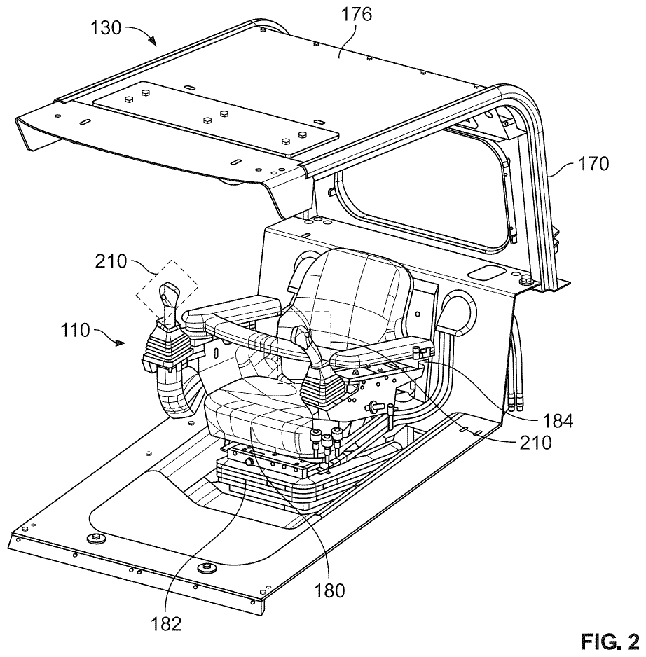

FIG. 1 illustrates a utility vehicle 100 that can be operated with an operator control system 110 as provided by this disclosure. As illustrated, the utility vehicle 100 can include a vehicle body 120, an operator cab 130, the operator control system 110, a pair of lift arms 140, an engine (not shown), a plurality of actuators (not shown), a hydraulic system (not shown), a utility attachment 150, and a pair of tracks 160. The vehicle body 120 has a front panel (not shown), a rear panel 170 (best shown in FIG. 2), lateral sides 172, 174, and a roof 176. The pair of lift arms 140 extend along the lateral sides 172, 174 of the vehicle body 120. The operator cab 130 is positioned between the pair of lift arms 140. In some forms, the lift arms 140 are coupled to the vehicle body 120 adjacent to the sides of the engine. In some forms, the utility vehicle 100 includes only a single lift arm 140. The single lift arm 140 can be coupled to the vehicle body 120 in front of the operator cab 130 toward the front end of the utility vehicle 100 or behind the operator cab 130 toward the rear end of the utility vehicle 100. In some forms, the single lift arm 140 can be coupled to the vehicle body 120 adjacent to the operator cab 130 toward one of the lateral sides 172, 174 and positioned to one side of a centerline X-X extending from the front end of the utility vehicle 100 to the rear end of the utility vehicle 100 while the operator cab 130 is positioned to the other side of the centerline X-X. In some forms, the single lift arm 140 can be coupled to the vehicle body 120 adjacent to, and in front of (or partially in front of), the operator cab 130, or adjacent to, and behind (or partially behind), the operator cab 130. In some forms, the engine may be located adjacent to the operator cab 130 toward one of the lateral sides 172, 174. In some forms the engine is located adjacent to, and in front of (or partially in front of), the operator cab 130, or adjacent to, and behind (or partially behind), the operator cab 130.

The utility attachment 150 can be provided in the form of an auger, backhoe, bale mover, blade, boom lift, breaker, broom, bucket, chipper, concrete tool, grader blade, grappler, land leveler, log splitter, material unroller, mower, mulcher, pallet fork, rake, rock wheel, roto tiller, scarifier, scraper, silage defacer, snow blower, snow push, sod unroller, spreader, stump grinder, stump remover, tree handler, trencher, and the like. It is further understood that although a pair of tracks 160 is illustrated with the utility vehicle 100, other mechanical forms of movement can be provided, such as via a set of wheels. Further, although an engine is described for utility vehicle 100, other forms of vehicle power can be provided. For example, utility vehicle 100 can be battery powered or powered through other electrical means. Although the utility vehicle 100 is depicted in FIG. 1 as a compact loader, it is to be understood that the operator control system 110 can also be provided with numerous other utility vehicles such as telescopic handlers, vertical lift, forklift, or other construction, agricultural, or warehousing vehicles. The operator control system 110 could likewise be adapted for a number of recreational vehicle applications, especially ATV's, side-by-sides, and other frequently rented vehicles with multiple levels of vehicle functionality and a plurality of controls.

FIG. 2 illustrates an enlarged view of the operator cab 130 of FIG. 1, without the lateral sides 172, 174 and front panel. The operator cab 130 includes an operator seat 180 and the operator control system 110 is located in proximity to the operator seat 180. Accordingly, a vehicle controller 210 according to an embodiment can be integrated with the operator control system 110 or the operator control system 110 may include a plurality of vehicle controllers 210. In some embodiments, the operator control system 110 may include one or more visual displays in addition to one or more vehicle controllers 210. The vehicle controller 210 can include one or more of a joystick, a keypad, a touchscreen, a touchpad, or other forms of a user interface that accepts user input via mechanical manipulation, voice feedback, or the like.

In some embodiments, the vehicle controller 210 can be located in proximity to the operator seat 180 such that an operator can comfortably control the machine using the vehicle controller 210 while seated in the operator seat 180. In some embodiments, the vehicle controller 210 may be attached to an operator control seat base 182 so that the vehicle controller 210 is located at the end of an operator seat armrest 184. In some embodiments, the vehicle controller 210 may be mounted to an interior side panel of the lateral sides 172, 174 (See FIG. 1) of the operator cab 130 or installed with a flexible attachment cord to allow for the vehicle controller 210 to be mounted to different locations within the operator cab 130 according to the operator's preference.

The operator control system 110 may additionally include one or more displays (not shown) located on or near the front panel of the utility vehicle 100 where the one or more displays are oriented to face the operator. Alternatively, in some embodiments, the one or more displays may be mounted to one or more of the interior side panels of the lateral sides 172, 174, or the roof 176 of the operator cab 130 such that the displays can be viewed by the operator without obstructing the line of sight out of the cab 130. The one or more displays may be configured to communicate with a processor within the vehicle controller 210 to provide operator instructions, display user inputs, show operating vehicle functions, alert the operator to errors or maintenance issues, and/or provide other types of notifications and information. In some embodiments, the displays can be configured to receive user inputs as well.

The utility vehicle 100 may include a plurality of sensors (not shown) and sensor configurations to monitor the vehicle functions, provide feedback and information to the processor of the vehicle controller 210, and identify vehicle conditions. Vehicle conditions may include, for example, the availability of optional features installed on a specific vehicle, the presence of an operator, the presence and/or proximity of potential hazards surrounding the vehicle, the temperature of the vehicle and/or its components, stability of the vehicle, vehicle speed, and other conditions of the vehicle. The plurality of sensors may also monitor vehicle functions and identify vehicle conditions. The embodiments described herein may include an operator presence sensor, a function status sensor, or a combination thereof. Both of the operator presence sensor and the function status sensor can include multiple sensing capabilities such as the sensing, detecting, and measuring capabilities of the other defined sensors. Further, any or all of the operator presence sensor, the function status sensor, or the plurality of actuators can be integrated as part of a centralized vehicle control unit that directs the functions of the vehicles and communicates feedback from the vehicle components.

The plurality of sensors may further include, but are not limited to: position sensors, pressure sensors, temperature sensors, force sensors, vibration sensors, motion sensors, occupancy sensors, magnetic sensors, piezo sensors, fluid property sensors, humidity sensors, strain gauges, photo optic sensors, radar-based sensor technologies, ultra-sonic sensors, flow switches, level switches, mechanical switches, pressure switches, capacitive switches, limiting switches and other types of measurement sensors and switches. In some embodiments, the utility vehicle 100 and the operator control system 110 can be configured with modular sensor configurations to allow for plug-and-play of different components and associated sensors depending on the vehicle type, applications, or feature package, for example. The sensors can further include analog sensors, digital sensors, wireless sensors, or other types of sensor configurations. These sensors can communicate with other vehicle components, including the processor of the vehicle controller 210 and the operator control system 110 using wired connection, wireless connection, or other means of electrical, mechanical, chemical, or pneumatic connection.

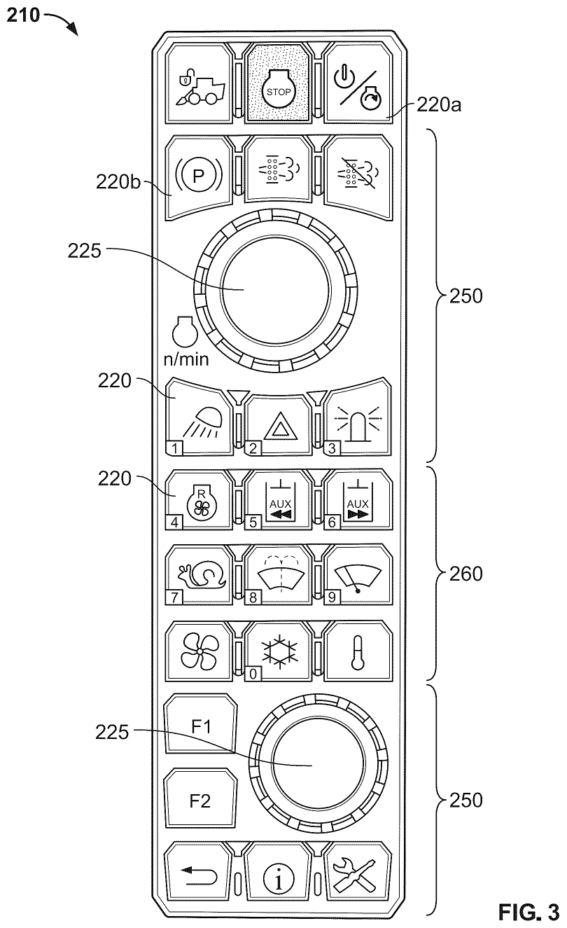

The vehicle controller 210 can be constructed out of a durable material, including but not limited to plastic, metal, rubber, or a combination thereof. In some embodiments, the vehicle controller 210 may be a digital display device comprising a screen. As shown in FIG. 3, the vehicle controller 210 is designed to receive a user input by a user selection through a plurality of interactive indicators 220 (see FIG. 3). In one embodiment, the interactive indicators 220 can be provided in the form of momentary pushbuttons. An operator can physically press the pushbutton downward to select the vehicle function associated with the interactive indicator 220. The interactive indicators 220 can be painted, etched, embossed, printed, or otherwise display an icon associated with a vehicle function. Additionally, the vehicle controller 210 can comprise a keypad, made of a layer of silicone rubber, shaped to cover a plurality of interactive indicators 220 and allow an operator to press an individual interactive indicator 220 without selecting adjacent interactive indicators 220. In this embodiment, the silicone rubber keypad can be painted or otherwise marked with the icons.

The paint can be a plurality of colors, including but not limited to red, black, and white. In one embodiment, when an operator presses the interactive indicator 220, the interactive indicator 220 depresses onto the center of a dome-shaped spring, which provides tactile feedback to the operator when the interactive indicator 220 is pressed. When the dome-shaped spring is depressed, an electrical contact is closed, providing an input to the vehicle controller 210 and to a processor associated with the specific interactive indicator 220 selected by the operator. In other embodiments, the interactive indicator 220 may be a digital button with a graphic icon indicating the digital button's association with a particular vehicle function. The interactive indictor 220 may also be provided in the form of a rotary dial 225 configured to rotationally move to enable a user to select or modify a user input. In some embodiments, the rotary dial 225 can include a momentary pushbutton to facilitate user selection and tactile feedback. In some embodiments, the rotary dial 225 can communicate with, or otherwise be connected to, a visual display (not shown) for user selection of specific vehicle functions.

The selective illumination of the interactive indicators 220 is controlled by the processor, wherein the processor activates a plurality of illumination elements (not shown). The illumination elements can be provided in the form of light emitting diodes (LEDs). While some embodiments describe using LEDs, it should be understood that other illumination elements can be used to selectively illuminate the vehicle controller 210. The LEDs can be provided in the form of a plurality of colored diodes, including but not limited to white, red, and green. The LEDs are mounted to a circuit board (not shown) having a control circuit and are located behind the plurality of interactive indicators 220, such that the icons on the interactive indicators 220 are backlight using the LEDs. The backlight from the LEDs can be visible through a top layer of the keypad.

In some forms, the icon of the interactive indicator 220 is illuminated, and a background of the interactive indicator 220 is not illuminated. In some forms, the background of the interactive indicator 220 is illuminated but not the icon of the interactive indicator 220. In some forms, both the background of the interactive indicator 220 and the icon of the interactive indicator 220 are illuminated in the same color and/or with the same animation pattern. In some forms, both the background of the interactive indicator 220 and the icon of the interactive indicator 220 are illuminated but not in the same color or not with the same animation pattern. Accordingly, numerous combinations of illumination and non-illumination are considered for the interactive indicators 220. Hereinafter, it is to be understood that descriptions of the interactive indicators 220, or the “icon” of the interactive indicators 220, being illuminated can refer to any combination of the icon of the interactive indicator 220 or the background of the interactive indicator 220 being illuminated or animated according to the foregoing description.

Additionally, the processor can be configured to adjust the brightness of the light output from the LEDs based on the input from a daylight sensor (not shown). The daylight sensor may be coupled to, or integrated with, the vehicle controller 210, coupled to the operator cab 130, coupled to the exterior of the utility vehicle 100, or provided in a plurality of other locations on the utility vehicle 100. In some forms, the daylight sensor can communicate with the processor or vehicle controller 210 through a wired or wireless connection. When the daylight sensor detects a predetermined light level of ambient light surrounding the utility vehicle 100, the processor can reduce or increase the LEDs light intensity to better illuminate the icons or backgrounds on the interactive indicators 220 in dim light or to cause the icons to become less visible in ambient lighting conditions.

The control circuit of the vehicle controller 210 includes the processor and at least one memory unit. The processor may be enabled to communicate with the displays, operator control system 110, and other components of the utility vehicle 100 using a: wired connection, networked connection, wireless connection, CANbus, proprietary protocol, or other means of electrical communication. In one non-limiting embodiment, CANbus communication can improve safety-related features including, but not limited to, message receipt confirmation, stop functionality, error checking, and similar functions. The memory unit can be configured to store a programmable sequence and a plurality of illumination patterns, and in some forms, the programmable sequence can be a startup sequence for powering on and enabling the utility vehicle 100. The startup sequence can also include enabling one or more of the plurality of vehicle functions.

Provided herein is a programmable vehicle startup system and method that can guide utility vehicle operators through the required steps or operations for vehicle startup and communicate to the operator which vehicle functions are installed or enabled, disabled, initiated or active, or inactive. The operator control system 110 is designed so that the user interface on the vehicle controller 210 is initiated when an operator presence sensor detects the presence of an operator. Typically, the operator presence sensor is integrated with, or coupled to, the operator seat 180, but other sensing devices may be used, including at least a sensor, or plurality of sensors, located inside the operator cab 130 or exterior to the operator cab 130. In some forms, one or more of the interactive indicators 220 can act as the operator presence sensor such that when the operator presses any one or more of the interactive indicators 220, either individually or in the form of a passcode entry, the vehicle startup sequence can be initiated. In some embodiments, once an operator is detected, the vehicle controller 210 selectively illuminates a first operation in the vehicle startup sequence. In one embodiment, one or more of the vehicle controller 210 and/or display(s) (not shown) can be activated or powered on to allow background functionality without visual indication, such as a sleep mode or silent wakeup process.

In one embodiment, the icons located on the interactive indicators 220 are selectively illuminated in a pulsating white illumination or a pulsating green illumination in association with one or more of the first operation, a second operation, or additional operations in the startup sequence. It will be recognized by one skilled in the art that the selective illumination is not limited to a specific color of illumination but can include one or more of a plurality of colored illuminations and illumination combinations. Referring to FIG. 3, the interactive indicator 220a, for example, can be illuminated to indicate to the vehicle operator that they should select the interactive indicator 220a as the first operation in the vehicle startup sequence corresponding to a first vehicle function to be initiated. In some embodiments, the sensory indication of the interactive indicators 220 may include one or more of a selective illumination, colored illumination, pulsating illumination, audible indicator, haptic feedback, or other types of sensory indication.

Generally, the first operation in the vehicle startup sequence includes providing power to the utility vehicle 100 using a first actuator, although additional embodiments may include a different first operation depending on the features installed in the vehicle. Additional examples of first operations in the vehicle startup sequence could include but are not limited to enabling the startup sequence using a passcode, releasing a secured lock, pressing a display switch, or providing another sensor-based input. In an example embodiment, after the interactive indicator 220 associated with the first operation in the vehicle startup sequence is illuminated, for example in a pulsating white illumination, the operator selects the first interactive indicator 220 associated with the first operation in the vehicle startup sequence. After the first interactive indicator 220 is selected and/or the first operation has been initiated or completed, a second interactive indicator 220 associated with the second operation in the vehicle startup sequence is selectively illuminated (or is provided with another sensory indication), for example in a pulsating white illumination. Also, the interactive indicator 220 associated with the first operation in the vehicle startup sequence is selectively illuminated differently, providing a second sensory indicator, for example, a solid green or pulsating green illumination, to indicate that the vehicle function associated with the first interactive indicator 220 has been initiated.

In some embodiments, the second operation in the vehicle startup sequence includes initiating the engine of the utility vehicle 100, which can be initiated using a second actuator. In an example embodiment, after the interactive indicator 220 associated with the second operation in the vehicle startup sequence is illuminated, for example in a pulsating white illumination, the operator selects the second interactive indicator 220 associated with the second operation in the vehicle startup sequence and then a third interactive indicator 220 associated with a third operation in the vehicle startup sequence is selectively illuminated (or have other sensory indication), for example in a pulsating white illumination. Also, the interactive indicator 220 associated with the second operation in the vehicle startup sequence is then selectively illuminated differently, providing a second sensory indicator, for example, a solid green or pulsating green illumination, to indicate the vehicle function associated with the second interactive indicator 220 has been initiated. Accordingly, the operator can be guided through the startup sequence via a series of illuminated interactive indicators 220 associated with various actuators that initiate designated vehicle functions.

In some embodiments, the second operation may include prompting the operator to enter a passcode before initiating the engine. The passcode can be a digital code prompt on a user interface or other type of display associated with the operator control system 110, and the passcode can be comprised of a sequence of alphanumeric characters or symbols. In some embodiments, a visual display or indication can be generated when an operator enters an incorrect passcode. Some embodiments may include other interface graphics generated to communicate alerts, notifications, recommendations, system maintenance, or other information to the user using one or more display(s).

In some embodiments, the third operation is associated with a third actuator for simultaneously unlocking two or more of the hydraulic system, parking brake, drive system, utility attachment(s), auxiliary hydraulics, or any combination of these systems. This combination of functions can reduce the number of selections of the interactive indicator 220 required to complete the startup sequence, which can reduce startup effort and overall startup time.

In some embodiments, the parking brake is unlocked as part of a fourth operation in the vehicle startup sequence by way of a fourth actuator. Accordingly, an interactive indicator 220b associated with the parking brake function can be illuminated in sequence in a pulsating white illumination, for example. Providing the fourth operation for fully independent control over the parking brake can be useful in scenarios where the operator would like to initiate a utility attachment, lift or tilt attachment, and/or utilize other auxiliary functions while the parking brake is initiated and engaged. This can improve the precision and safety of certain work operations, such as when operating the utility vehicle 100 on an incline.

In some embodiments, the parking brake feature can be activated simultaneously with a drive disable feature. In this example, the parking brake feature can be initiated in response to a specific action or input such as when an operator stands up from the operator seat, when the interactive indicator 220b associated with the parking brake feature is selected by the operator, and/or when other pre-determined or programmed functions in the vehicle startup sequence or operating controls of the utility vehicle 100 are activated.

In other embodiments, the interactive indicator 220a corresponds to both powering the utility vehicle 100 and initiating the engine. Accordingly, in some forms, the operator will press the interactive indicator 220a two times, the first time causing the first actuator to power on the utility vehicle and the second time causing the second actuator to initiate the engine. In some forms, the operator can press and hold the interactive indicator 220a in order to power on the utility vehicle 100 and initiate the engine without needing to press the interactive indicator 220a multiple times. In the “press and hold” configuration, the vehicle startup sequence begins by selectively illuminating the interactive indicator 220a associated with the first operation in the vehicle startup sequence, wherein the selective illumination is a pulsating white illumination, and as the interactive indicator 220a is held down for a first predetermined period of time, such as 3 seconds, the interactive indicator 220a changes to a pulsating green illumination to indicate that the vehicle has been powered-on, and then finally the interactive indicator 220a changes to a static green illumination if the interactive indicator 220a is held down for an additional second predetermined period of time to indicate that the engine has been initiated. The pulsating white illumination indicates what the first operation in the vehicle startup sequence is, the pulsating green illumination 240 indicates that the utility vehicle power-on function has been selected but the engine has not yet been initiated, and the static green illumination 240 indicates that both the power and engine to the utility vehicle 100 have been initiated and are active.

Generally, the utility vehicle 100 includes several base features 250, with additional features that are capable of being installed either by a vehicle manufacturer, by a vehicle distributor, or by the end user or operator. These additional features can be called “high take rate options” 260 in some embodiments. While some additional features may require extensive labor and special skill to install, other features may be modular or otherwise capable of being added or removed from the utility vehicle 100 using a plug-and-play configuration. FIG. 3 includes brackets to show an example embodiment of the vehicle controller 210 with interactive indicators 220 representing different features of both the base configuration 250 and high take rate option 260. Base configuration features 250 can include, but are not limited to one or more work lights, one or more beacons, and/or a parking brake. High take rate options 260 can include, but are not limited to HVAC, windshield wipers, washers, flashers, fan reversing, and other similar functions.

Some vehicle startup sequences may include several operations that are not required to be performed in a specific order. For example, after power is provided to the utility vehicle 100 and the engine has been initiated, the processor may be programmed to allow a plurality of different vehicle functions to be selected and initiated. As FIG. 3 illustrates, the interactive indicators 220 can include a variety of icons to indicate to the operator which vehicle function is associated with each interactive indicator 220. Although visual picture icons are shown in FIG. 3, it should be recognized that the icons could also include text, voice, and tactile-based features to convey information to the operator. The vehicle functions can be initiated using a plurality of actuators that are associated with each interactive indicator 220 and controlled by the control circuit of the operator control system 110. Some vehicle functions can be initiated regardless of the status of the vehicle startup sequence. For example, some of these available functions may include, but are not limited to a vehicle lighting system, windshield wiper system, temperature control for the operator cab, and the parking brake or braking system. In some embodiments, power must be provided to the utility vehicle 100 for these features to operate, but some embodiments may allow these features to operate on battery power or by another power source. Some embodiments provide a vehicle controller 210 with interactive indicators 220 physically arranged in a consecutive order (e.g., horizontally, vertically, or some other order) according to the steps in the vehicle startup sequence. Generally speaking, the vehicle startup sequence can be preprogrammed or user defined such that the vehicle startup sequence is customizable by the operator or the dealership such that the vehicle startup sequence steps, and the order of the steps, are customizable. In some forms, a default vehicle startup sequence is provided, and after customization, the vehicle startup sequence can be reset back to the default startup sequence. In some forms, the vehicle startup sequence programming can be modified or defined via one or more of the vehicle controller 210, the display, or a mobile device in communication with the vehicle controller 210.

In some embodiments, the vehicle controller 210 can be illuminated to indicate which vehicle functions or features are installed in a specific utility vehicle 100 and to indicate which vehicle functions or features are initiated. A plurality of function status sensors can be configured to communicate with the processor to provide feedback to the processor related to the features that are installed and the functions that have been initiated. Thus, the feedback can then be provided to the operator through a sensory indication on the vehicle controller 210 interface, such as via the illumination of the interactive indicators 220. The sensory indication can include selective illumination, sounds, haptics, other means of feedback, or any combination thereof.

In one embodiment, the sensory indication may include selective illumination, wherein the selective illumination includes a plurality of illumination settings associated with the status of a vehicle function or feature. The plurality of illumination settings are controlled by the processor, which adjusts the LED backlight behind the interactive indicators 220 to provide a visual indication to the operator of the status of a particular vehicle function. For example, a first sensory indicator, e.g., a first illumination setting, can indicate that a vehicle function status is “installed” on the utility vehicle 100 and, thus, is available to be initiated. A second sensory indicator, e.g., a second illumination setting can indicate that a vehicle function status is “initiated”. A third sensory indicator, e.g., a third illumination setting can indicate a vehicle function status is “not installed”. In one embodiment, an inactive or unavailable vehicle function may be displayed using a blank display (e.g., dead front display) instead of an icon on the interactive indicator 220.

For example, the first illumination setting may include selectively illuminated interactive indicators 220 that are selectively illuminated in a white illumination. Accordingly, the white illumination is associated with the vehicle features that are installed on the specific utility vehicle being operated by the controller. The second illumination setting may include selectively illuminating the interactive indicators corresponding to the vehicle functions that are currently initiated, for example in a green illumination. Finally, the third illumination setting is represented as the interactive indicators not being illuminated at all, which corresponds to vehicle features that are not installed or available to the operator. Other specialized sensory indicators are contemplated, such as selective illumination with a red light, to indicate that the associated vehicle features are related to safety features including STOP, the parking brake, or the hazard lights. In some embodiments, the red illumination can also be used to indicate a particular vehicle function (e.g., the hydraulic system) is locked. It should be recognized that the sensory indications and the illumination settings are not limited to those described herein and each illumination can be used interchangeably or in combination with others to indicate various function statuses.

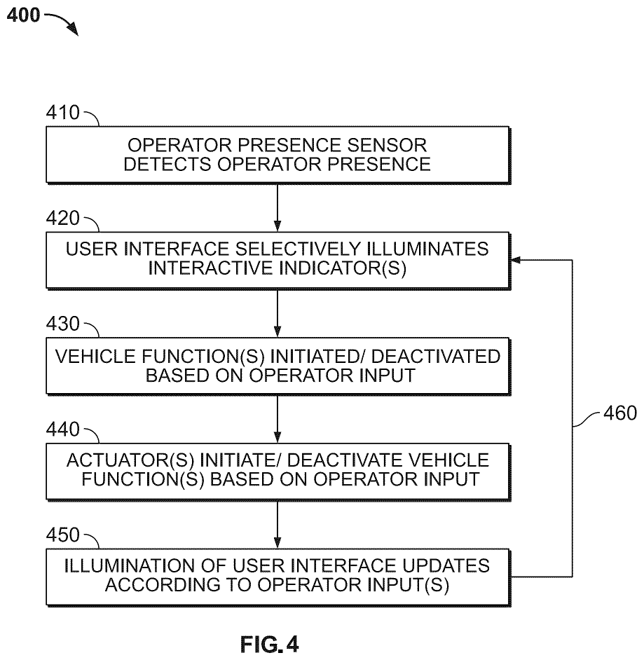

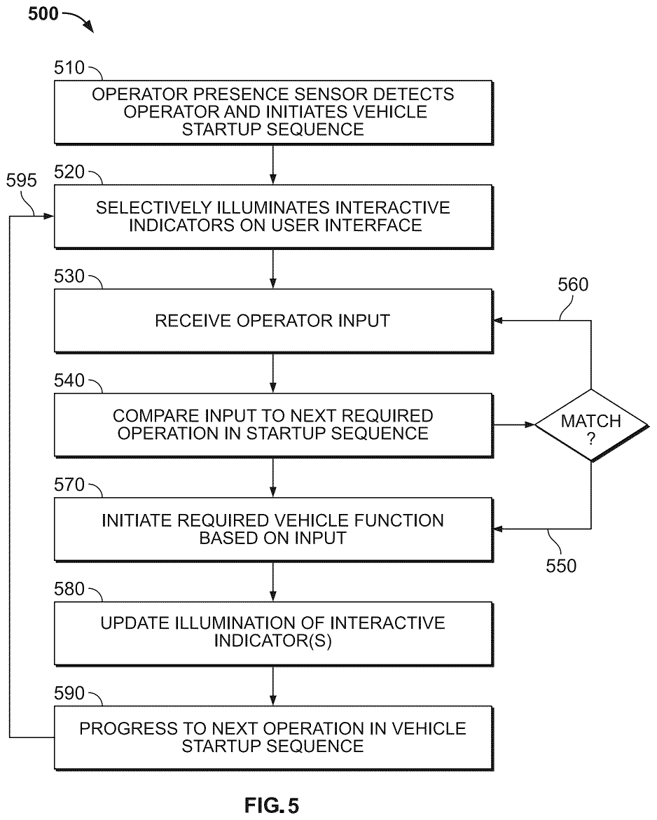

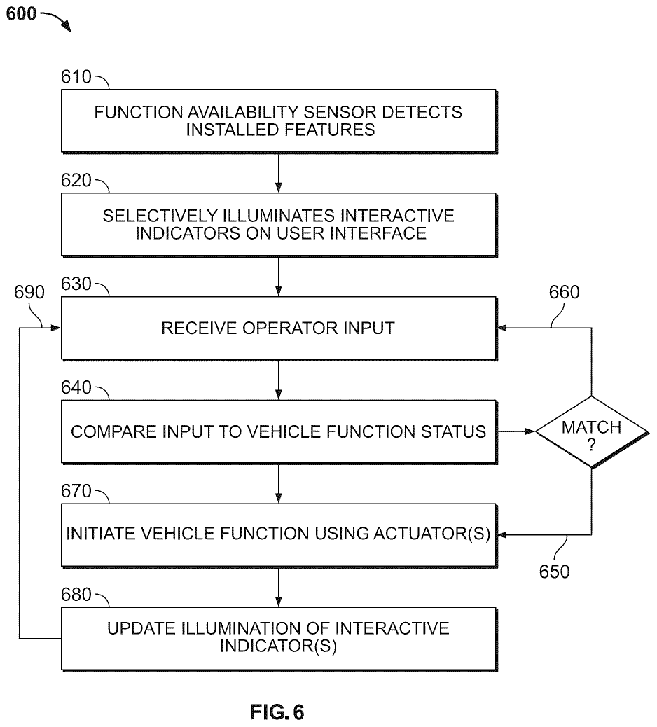

FIG. 4 illustrates an example embodiment of a method 400 for operating the operator control system 110 using the vehicle controller 210. The method 400 is an example of the overarching functionality of the keypad of the vehicle controller 210. The overarching functionality of the keypad can apply to aspects of both a method 500 for guiding the operator through the vehicle startup sequence described in more detail below with respect to FIG. 5 and a method 600 shown in FIG. 6 for determining and displaying which features or vehicle functions are installed on the utility vehicle 100. In step 410, the operator control system 110 detects the presence of an operator using at least one operator presence sensor. The operator presence sensor is in communication with the processor of the vehicle controller 210, which activates the user interface of the vehicle controller 210. For example, in step 420, the user interface is activated and the backlight LEDs behind the interactive indicators 220 are selectively illuminated in an illumination setting, such as the first illumination setting. The backlight LEDs can be controlled by the processor to be activated with a plurality of illumination pattern settings, wherein the plurality of illumination settings may include different colors, pulsating illumination, static illumination, or a combination thereof.

Each interactive indicator 220 is associated with a vehicle function or feature, such that when the operator presses an interactive indicator 220, which corresponds to a vehicle function, the processor, in step 430, receives the user input and sends a signal in step 440 to the control circuit to initiate the vehicle function associated with the interactive indicator via a corresponding actuator. After the vehicle function is initiated, a function status sensor, or plurality of function status sensors, detects that the vehicle function status is initiated. In some embodiments, the status of one or more vehicle functions can be pre-defined or input by a user via the vehicle controller 210, the display, or a mobile device in communication with the processor. For example, the operator can manually set a vehicle function as being installed or enabled (or disabled) such that the status of the vehicle function being enabled or disabled is not determined by the output from the vehicle status sensor. In step 450, the vehicle function sensor(s) communicate with the control circuit and/or the processor to update the vehicle function status, and the processor sends a signal to the backlight LED associated with the interactive indicator 220 for the vehicle function that has been initiated. The backlight LED is then selectively illuminated with an illumination pattern setting corresponding to the vehicle function status being initiated and active, such as the second illumination setting.

When the operator selects the same interactive indicator 220 for the initiated vehicle function, the processor receives the operator input and sends a signal to the control circuit to disengage, or otherwise deactivate the vehicle function in step 460, where the processor is reset to step 420. When the function status sensor, or plurality of function status sensors, detects the vehicle function status is deactivated, a signal of the vehicle function status being deactivated is sent to the control circuit and/or the processor. The processor then controls the backlight LED to be selectively illuminated with an illumination setting corresponding to the vehicle function status being deactivated, but still yet installed, such as the first illumination setting. As mentioned above, the principles of the method 400 shown in FIG. 4 can be combined with, or inform, the principles of the method 500 for guiding the operator through the vehicle startup sequence in FIG. 5 and the principles of the method 600 for displaying the installed and initiated vehicle functions on a utility vehicle 100, as shown in FIG. 6.

FIG. 5 shows an example embodiment of the method 500 for guiding the operator through the vehicle startup sequence. During the method 500, sensory feedback is provided to the operator to guide the operator through the operations for powering on and activating vehicle functions on the utility vehicle 100. As mentioned above, the vehicle controller 210 can include the control circuit with the processor and the memory for storing the programmable vehicle startup sequence. In step 510, the operator control system 110 detects the presence of an operator using at least one operator presence sensor and initiates the vehicle startup sequence. The operator presence sensor is in communication with the processor in the vehicle controller 210, which activates the user interface of the vehicle controller 210 in step 520. In one embodiment, when the user interface is activated in step 520, the backlight LEDs behind the interactive indicators 220 are selectively illuminated. The selective illumination can include a fourth illumination setting, wherein the fourth illumination setting can include a pulsating white illumination to selectively illuminate the interactive indicator 220 associated with the first operation in the vehicle startup sequence, such as interactive indicator 220a.

When an operator selects the interactive indicator 220, each interactive indicator 220 being associated with a vehicle function, the processor receives the user input in step 530 and compares the user input to the programmable startup sequence in step 540 to determine if the user input correctly matches the next required vehicle operation in the startup sequence. In some forms, the user interface will not accept any user input in step 530 until a passcode is entered or reentered via the display or will not accept any input besides the passcode via the user interface until the correct passcode is entered.

If the user input matches the next required vehicle operation in the vehicle startup sequence, the processor communicates in step 550 with the control circuit to initiate the required vehicle function at step 570. When each of the vehicle functions are initiated, a function status sensor, or plurality of function status sensors, detects that the vehicle function is activated and sends a signal at step 580 to the control circuit and/or the processor indicating the vehicle function status is initiated. The processor then updates the backlight LED(s) for the interactive indicator 220 associated with the vehicle function to be selectively illuminated by the illumination setting corresponding to the vehicle function status of “initiated”, such as the second illumination setting. After an operation in the vehicle startup sequence has been completed, the processor in step 590 iteratively progresses the vehicle startup program to request initiation of the next operation in the programmed startup sequence. Accordingly, as shown by step 595, the processor controls the backlight LED associated with the next operation in the startup sequence in a manner that the interactive indicator 220 associated with the next operation is selectively illuminated according to an illumination setting, such as the first illumination setting.

However, if in step 540 the user input does not match the required vehicle operation in the vehicle startup sequence, the processor waits in step 560 to receive another user input. In some forms, the processor will provide sensory feedback to the operator via the interactive indicators 220 to indicate that the selected interactive indicator 220 is not the correct interactive indicator 220 associated with the next operation in the vehicle startup sequence. In one embodiment, when an incorrect user input is received with respect to the startup sequence, the operator control system 110 can provide sensory feedback indicating the input is incorrect. In another embodiment, a display (not shown) can provide a sensory indication and/or a notification that an incorrect input was received. The display may provide a visual demonstration, by generating a user interface graphic of the next step in the sequence. In one embodiment, the incorrectly selected interactive indicator 220 will remain in the third illumination setting and/or as a dead front until the correct interactive indicator 220 is selected.

As a non-limiting example, with respect to the method 500, the operator presence sensor can be provided in the form of a seat switch. Accordingly, when the operator sits down into the operator seat 180, triggering the seat switch, the operator presence sensor detects the presence of the operator in step 510. In step 520, in response to detecting the presence of the operator, the processor will illuminate the interactive indicator 220a of the vehicle controller 210, which is the power button and corresponds to the first step in the startup sequence of powering the vehicle on, in a pulsating white illumination. In step 530, the operator presses the interactive indicator 220a. In step 540, the processor compares the pressing of the interactive indicator 220a with the first step in the startup sequence. Because the interactive indicator 220a is associated with the first step in the startup sequence, the processor will determine a match with the startup sequence in step 550. In step 570, the processor will cause the vehicle to power on. Once the vehicle is powered on, the processor will update the illumination of the interactive indicator 220a in step 580, for example to be a solid white illumination. Here, because interactive indicator 220a is also used to initiate the engine, which is the second step in the vehicle startup sequence, the method will return in step 595 to illuminate the interactive indicator 220a again in a pulsating white illumination in step 520. In step 530, the operator presses the interactive indicator 220a again. In step 540, the processor compares the pressing of the interactive indicator 220a with the second step in the startup sequence. Because the interactive indicator 220a is also associated with the second step in the startup sequence, the processor will determine a match with the startup sequence in step 550. In step 570, the processor will cause the engine to initiate.

Once the engine is initiated, the processor will update the illumination of the interactive indicator 220a in step 580, for example to be a solid white illumination. In step 595, the method 500 will return to step 520 to illuminate the third step in the vehicle startup sequence, which is unlocking the hydraulics. Accordingly, in step 520, the processor will illuminate the interactive indicator 220 associated with unlocking the hydraulics. In step 530, the operator will select the interactive indicator 220 associated with unlocking the hydraulics. In step 540, the processor will compare the operator selection with the third step in the vehicle startup sequence, e.g., unlocking the hydraulics. If the operator has correctly selected the interactive indicator 220 associated with unlocking the hydraulics, in step 550, the processor will determine a match and initiate the unlocking of the hydraulics in step 580. If at any point the operator does not select the interactive indicator associated with the next step in the vehicle startup sequence, the processor will determine that the selection is not a match in step 560. In some forms, the vehicle controller 210 will provide feedback, such as illuminating at least a portion of the vehicle controller 210 in a red illumination to indicate to the user that the wrong button has been pressed. Alternatively, the processor will simply wait until the operator correctly selects the interactive indicator associated with the next step in the vehicle startup sequence. Once the vehicle startup sequence has completed, the vehicle controller 210 can be illuminated according to the installed and active illuminations described below with respect to the method 600.

In some forms, the method 500 for guiding the operator through the vehicle startup sequence can be reset if the operator presence sensor detects the operator is no longer present in the utility vehicle 100, or if the interactive indicator 220 associated with the first operation in the vehicle startup sequence is selected again by the operator. Also, if the operator presence sensor detects the operator is no longer present in the utility vehicle 100, certain vehicle functions may be disabled. For example, the parking brake feature may automatically engage, thereby disabling the drive feature. Other vehicle functions may remain operational even if the operator is no longer seated including, but not limited to work lights, vehicle lights, HVAC, various safety features, etc. In some embodiments, the system may receive a signal from the operator presence sensor and generate an interface graphic on the one or more displays indicating the operator is no longer seated.

In another embodiment, if the operator presence sensor detects the operator is no longer present in the utility vehicle 100, or the first operation in the vehicle startup sequence is selected again, the vehicle controller 210 will disable the vehicle functions and may power down the engine. The method 500 can further include aspects of the embodiment of the method 400 of FIG. 4 including, but not limited to, disabling a vehicle function after being selected again by the operator after the vehicle function has been initiated.

FIG. 6 illustrates an example embodiment for the method 600 for determining and displaying which features or vehicle functions are installed on the utility vehicle 100 by using selective illumination of the plurality of interactive indicators 220 located on, or integrated with, the vehicle controller 210. In step 610, a function status sensor or plurality of sensors detects whether a vehicle function or feature is installed. The function status sensor, or plurality of sensors, is designed to communicate either through a wired or wireless connector to a control circuit and/or the processor in the operator control system 110. If the function status sensor detects that a feature is installed, the function status sensor will send a signal in step 620 to the control circuit and/or the processor and the processor will selectively illuminate the backlight LEDs located under the plurality of interactive indicators 220 associated with each vehicle function or feature. There may be a plurality of illumination settings associated with the different vehicle function statuses, similar to the illumination settings described in the embodiments above. For example, the first illumination setting can be used to indicate that particular vehicle functions that are installed but are not initiated. The second illumination setting can be used to indicate that particular vehicle functions are installed and initiated.

Although the second illumination setting is described above as a green illumination, in some forms, a red illumination may be used to indicate that certain vehicle functions are installed and initiated (e.g., hazard lights). Next, as mentioned above, the third illumination setting may include a lack of illumination used for vehicle functions that are not installed or otherwise unavailable to the operator. At step 630, the operator selects one of the interactive indicators 220, each interactive indicator 220 being associated with a vehicle function, and the processor receives the user input. Then, at step 640, the processor compares the user input to the out of the vehicle function status to determine if the vehicle function has a status of “installed”. If the user input matches with an installed vehicle function, the processor communicates at step 650 with the control circuit to initiate the selected vehicle function at step 670. If the user input does not match a vehicle function with a status of “installed”, the processor waits at step 660 to receive another user input.

As a non-limiting example, with respect to the method 600, step 610 can involve detecting via the function status sensor that a vehicle auxiliary attachment, which can be initiated via the vehicle controller 210, such as an auger, backhoe, bale mover, blade, boom lift, breaker, broom, bucket, chipper, concrete tool, grader blade, grappler, land leveler, log splitter, material unroller, mower, mulcher, pallet fork, rake, rock wheel, roto tiller, scarifier, scraper, silage defacer, snow blower, snow push, sod unroller, spreader, stump grinder, stump remover, tree handler, trencher, is electrically connected to the vehicle. If the vehicle auxiliary attachment is detected, the corresponding interactive indicator 220 on the vehicle controller 210, e.g., the corresponding momentary pushbutton, will illuminate in a white illumination to indicate that the vehicle auxiliary attachment is available for initiation but is not currently initiated. If the vehicle auxiliary attachment is not detected, the corresponding interactive indicator 220 on the vehicle controller 210 will not be illuminated, e.g., displayed as a dead front to indicate that the auxiliary vehicle attachment is not available. Next, in step 630, the operator selects the interactive indictor 220 corresponding to the vehicle auxiliary attachment. The processor of the vehicle controller 210 will then compare the operator selection to the status of the vehicle auxiliary attachment detected by the function status sensor in step 640. If the vehicle auxiliary attachment is available, the processor will determine a match in step 650 and in step 670, the processor communicates with the control circuit to initiate the auxiliary vehicle attachment. Once initiated, the processor will update the corresponding interactive indicator 220 in step 680 to illuminate in a green illumination to indicate that the auxiliary vehicle attachment has been initiated. If, however, the vehicle auxiliary attachment is not available, the processor waits at step 660 for another operator input. Further, if the vehicle auxiliary attachment is already initiated, when the operator presses the corresponding interactive indicator 220 in step 630, the vehicle auxiliary attachment will be deactivated, and the corresponding interactive indicator 220 will change from the green illumination to the white illumination to indicate that the vehicle auxiliary attachment is available, but no longer initiated.

In some embodiments, the vehicle function status may require a passcode in order to initiate the function. When the selected vehicle function is initiated, a function status sensor or plurality of sensors detects when the vehicle function is initiated and sends a signal to the control circuit and/or the processor indicating the vehicle function status is initiated. The processor, in step 680, controls the backlight LED(s) for the interactive indicator 220 associated with the vehicle function to be selectively illuminated by an illumination setting corresponding to the vehicle function status of “initiated”, such as the second illumination setting. In step 690, the processor waits to receive another operator input. If the operator presence sensor detects that the operator is no longer present in the vehicle, the vehicle controller can disable some of the vehicle functions. In some embodiments, if the operator presence sensor detects that the operator is no longer present in the vehicle, the vehicle controller can disable all hydraulic-based features and/or power down the engine. Additionally, if an operator selects an interactive indicator 220 associated with an initiated vehicle function, the processor can send a signal to the control circuit to disable or deactivate the vehicle function.

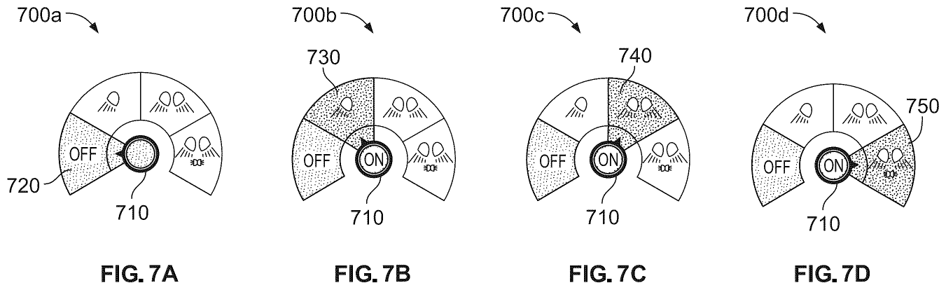

FIGS. 7A-7D illustrate various visual graphics 700a, 700b, 700c, 700d that can be generated on the one or more displays (not shown) associated with the vehicle controller 210. The visual graphics 700a, 700b, 700c, 700d can correspond to a vehicle function and a vehicle function status as selected by the user using the interactive indicators 220 and/or the rotary dial 225 (shown in FIG. 3). As an example, the visual graphics 700a, 700b, 700c, 700d correspond with a working light vehicle function. A status indicator 710 can be updated based on the user selection of the interactive indicator 220 associated with the working light vehicle function and the status of the working light vehicle function. For example, when the working lights are installed but are turned off, the corresponding interactive indicator 220 on the vehicle controller 210 can be illuminated with the first illumination setting and the status indicator 710 on the display will be red and/or indicate an “off” status as shown in FIG. 7A. A status indicator 720 can also be provided in the form of a red illumination of an icon or the word “off”, for example, to indicate the “off” status.

In one embodiment, the user may press or select the interactive indicator 220 associated with a particular vehicle function to initiate the vehicle function, such as the working light vehicle function, thereby updating the selective illumination of the associated interactive indicator 220 to the second illumination setting and correspondingly, the status indicator 710 on the display will be updated to illuminate in a blue (or other) color and/or indicate an “on” status via a status indicator 730 through the illumination of a vehicle function icon on the display, such as a working light icon as shown in FIG. 7B. In some embodiments, the user can use the visual display to scroll or interactively move through vehicle function options using the rotary dial 225, wherein the available vehicle function options match those installed on the vehicle controller 210.

In one embodiment, the user may press or select the interactive indictor 220, or the rotary dial 225, for an already initiated vehicle function, the already initiated vehicle function being indicated by the status indicator 710 and the second illumination setting of the interactive indicator 220 on the vehicle controller 210. In some embodiments, this may turn the vehicle function status to the “off” status, and the status indicators 710, 720 will be illuminated again corresponding to the “off” status as described above and shown in FIG. 7A. However, for some vehicle functions, there may be a plurality of alternate function statuses available and, thus, a plurality of alternate function status indicators 740, 750 as shown in FIGS. 7C and 7D. For example, when the system receives a first user input selecting the interactive indicator 220 corresponding to the working lights function, the working lights function is initiated and the front lights are turned on, as shown by the function status indicator 730 in FIG. 7B, which is the illumination of a single working light icon in a blue illumination.

If the user selects the working lights interactive indicator 220 again, either by pressing the interactive indicator 220 or pressing a button on the rotary dial 225, the system can initiate both the front and rear working lights as shown by the function status indicator 740 in FIG. 7C, which is the illumination of two working light icons in a blue illumination. In this example, the interactive indicator 220 on the vehicle controller 210 can remain in the second illumination setting. Further, the user can select the interactive indicator 220 again to turn the working lights into a bright mode as shown by the function status 750 in FIG. 7D, which is the illumination of two working light icons and a brightness icon in a blue illumination. In the bright mode, the interactive indicator 220 on the vehicle controller 210 can still remain in the second illumination setting. After the user selects the interactive indicator 220 associated with a specific vehicle function and cycles through all possible function statuses or operating states, the vehicle function will be deactivated and return to an “off” function status and the function status indicator 710, 720 will be illuminated again corresponding to the “off” status as described above and shown in FIG. 7A.

In one embodiment, other vehicle functions may include a plurality of operating states and statuses, including but not limited to HVAC, fan reversing, other lighting systems, wipers, and other vehicle functions. It will be understood by one skilled in the art that the display colors, symbols, and specific statuses shown and described in connection with FIGS. 7A-7D can include a plurality of color and label options. Also, even though the function status indicators 710, 720, 730, 740, 750 of the display can be correlated with, or correspond to, the illumination settings of the interactive indicators 220 of the vehicle controller 210, one of skill in the art would understand that the function status indicators 710, 720, 730, 740, 750 and the illumination settings can be illuminated independent of one another. Additionally, the vehicle features described throughout the specification and other vehicle functions of a utility vehicle can be configured with a plurality of individual status and operating states and are not limited to the specific disclosures provided herein.

In other embodiments, other configurations are possible. For example, those of skill in the art will recognize, according to the principles and concepts disclosed herein, that various combinations, sub-combinations, and substitutions of the components discussed above can provide appropriate control for a variety of different configurations of utility vehicles, work machines, operator control systems, and so on, for a variety of applications.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. An operator control guidance system for a utility vehicle, the operator control guidance system comprising:
a vehicle controller mounted within an operator cab of the utility vehicle, the vehicle controller including:
a control circuit having a processor and a memory unit configured to store a programmable sequence, the programmable sequence including a first operation and a second operation;
a user interface comprising a plurality of interactive indicators, wherein the plurality of interactive indicators include at least one user interface icon and the plurality of interactive indicators correspond to a plurality of actuators; and
an illumination element, wherein the illumination element is configured to selectively illuminate each of the plurality of interactive indicators,
wherein the first operation includes illuminating a first interactive indicator of the plurality of interactive indicators, and the second operation includes illuminating a second interactive indicator of the plurality of interactive indicators.

2. The operator control guidance system of claim 1, wherein the control circuit includes a power mechanism configured to initiate a plurality of vehicle functions.

3. The operator control guidance system of claim 1, wherein the processor is in communication with an operator presence sensor, which is configured to detect a presence of a vehicle operator.

4. The operator control guidance system of claim 3, wherein the operator presence sensor is a switch in communication with a seat of the utility vehicle.

5. The operator control guidance system of claim 1, wherein the programmable sequence includes a vehicle startup sequence that comprises a plurality of operations configured to provide power to the utility vehicle, initiate an engine, and enable one or more functions of the utility vehicle.

6. The operator control guidance system of claim 5, wherein the first operation, the first interactive indicator, and a first actuator correspond with providing power to the utility vehicle, and the second operation, the second interactive indicator, and a second actuator correspond to initiating the engine.

7. The operator control guidance system of claim 1, wherein the vehicle controller executes the programmable sequence and initiates the second operation after the first operation has been initiated.

8. An operator control system for a utility vehicle, the operator control system controlled by a user and coupled to the utility vehicle, the operator control system comprising:
an operator seat in communication with an operator presence sensor;
a vehicle controller comprising a user interface and a control circuit, wherein the user interface is configured to receive an operator input;
the control circuit comprising a processor and a memory unit configured to store a programmable sequence, wherein the processor is in communication with the operator presence sensor and the user interface, the processor being configured to:
selectively illuminate the user interface based on an output of the operator presence sensor;
selectively illuminate the user interface based on the operator input;
iteratively update a status of the programmable sequence based on the output of the operator presence sensor and the operator input; and
enable at least one of a plurality of functions of the utility vehicle and selectively illuminate the user interface based on the status of the programmable sequence.

9. The operator control system of claim 8, wherein the at least one of the plurality of functions of the utility vehicle is enabled after a passcode is entered via the user interface.

10. The operator control system of claim 8, wherein the user interface includes a plurality of interactive indicators.

11. The operator control system of claim 8, wherein the selective illumination of the user interface includes one or more of a pulsating illumination or a solid illumination.

12. The operator control system of claim 8, wherein the processor updates the status of the programmable sequence if the operator input matches a next operation in the programmable sequence.

13. The operator control system of claim 8, wherein the programmable sequence includes a plurality of operations configured to provide power to the utility vehicle, initiate an engine, and initiate one or more functions of the utility vehicle.

14. The operator control system of claim 13 further comprising a plurality of actuators, wherein a first operation, a first interactive indicator, and a first actuator correspond with a first vehicle function of the programmable sequence, and a second operation, a second interactive indicator, and a second actuator correspond to a second vehicle function of the programmable sequence.

15. A vehicle startup sequence method for a utility vehicle, the method comprising:
providing a plurality of interactive indicators on a user interface, the plurality of interactive indicators corresponding to a plurality of vehicle functions;
providing a first sensory indicator for a first operation in a vehicle startup sequence, wherein the first operation in the vehicle startup sequence includes selecting a first interactive indicator of the plurality of interactive indicators;
receiving a first selection of the first interactive indicator;
initiating a first vehicle function of the plurality of vehicle functions after receiving the first selection of the first interactive indicator and providing a second sensory indicator of the first operation in the vehicle startup sequence;
providing the first sensory indicator for a second operation in the vehicle startup sequence after initiating the first vehicle function, wherein the second operation in the vehicle startup sequence includes selecting a second interactive indicator of the plurality of interactive indicators; and
initiating a second vehicle function of the plurality of vehicle functions after receiving a second selection of the second interactive indicator and providing the second sensory indicator of the second operation in the vehicle startup sequence.

16. The method of claim 15, further comprising the step of receiving a signal from an operator presence sensor for detecting a presence of an operator, wherein the first sensory indicator of the first operation in the vehicle startup sequence is provided in response to sensing the presence of the operator.

17. The method of claim 15, wherein powering the utility vehicle is the first operation in the vehicle startup sequence, and initiating an engine of the utility vehicle is the second operation in the vehicle startup sequence.

18. The method of claim 15, further comprising the step of illuminating each of the plurality of interactive indicators and enabling a remainder of the plurality of vehicle functions after initiating the second vehicle function and detecting a completion of the vehicle startup sequence.

19. The method of claim 15, wherein the first sensory indicator is a pulsating illumination and the second sensory indicator is a solid illumination.

20. The method of claim 15, wherein initiating the second operation in the vehicle startup sequence occurs after initiating the first operation in the vehicle startup sequence.

21-39. (canceled)
